(19) United States
(12) Patent Application Publication
(10) Pub. No.: US 2003/0187529 A1
(43) Pub. Date: Oct. 2, 2003

(54) Computer audio system

(76) Inventor: Steven K. Lee, Minneapolis, MN (US)

Correspondence Address: Beck & Tysver, P.L.L.C., Suite 100, 2900 Thomas Avenue S., Minneapolis, MN, 55416, US

(21) Appl. No.: 10/359,842

(22) Filed: Feb. 6, 2003

Related U.S. Application Data
(60) Provisional application No. 60/369,209, filed on Apr. 1, 2002.

(51) Int. Cl. G06F 17/00

(52) U.S. Cl. 700/94

(57) ABSTRACT

The present disclosure is directed to an improved audio system and method for a computer system such as a desktop computer or a laptop computer. The improved audio system enables the computer system to output a high quality audio signal that is similar to many dedicated high-end consumer or professional audio components. In other words, the output from the computer systems is as good as the signal output from audio components in a home entertainment system. In one example described below, this is accomplished by providing a component called a sample rate converter to the computer system. The sample rate converter in the example upsamples a standard 16 bit, 44.1 kHz digital audio signal inside the computer system into a 24 bit, 192 kHz enhanced digital audio signal. This signal is as good as, or better than, the signals coming from single function audio component that can cost more than the entire computer system.

### REFERENCE TO CO-PENDING APPLICATION

The present application claims priority to a U.S. provisional application for patent filed on Apr. 1, 2002, and having serial No. 60/369,209.

### BACKGROUND

The present disclosure relates to computers. In particular, the present disclosure relates to audio components and circuits of personal computers.

Personal computers include both desktop and laptop models. Desktop models typically include a housing, or cabinet, containing various electronic parts such as processors on a motherboard, magnetic disk drives, optical disc drives, network cards, sound cards, or the like. The desktop computer typically has a monitor, keyboard and mouse, or similar devices that are electrically coupled to the parts within the housing. Laptop computers typically include the electronic parts, display, keyboard, and a pointing device all within the same compact housing.

As personal computers become more powerful, they are called upon to perform a greater variety of tasks. Long gone are the days when computer software consisted of a word processor, spreadsheet, database, and perhaps some rudimentary game. Today's computers communicate over the Internet, play and record DVD's and CDs, store and manipulate digital photographs, and manage a library of music, among other things. Increasingly, personal computers are able to enhance the user's lifestyle rather than to provide just an office-type productivity tool.

One area, however, in which personal computers have not kept up is in audio output. Personal computers output audio signals that do not provide the same high quality sound of home audio components. This is unfortunate because a user may store and play a vast song library, create and manipulate song playlists for every occasion, or watch DVDs, but cannot realize a high fidelity audio output.

The audio system on typical personal computers includes a sound card that accepts an analog audio signal from a variety of sources. These sources include the computer's motherboard to play a stored song library, sound from games, or streaming audio from the Internet, and other sources such as DVD drives. These sources provide an analog signal to the sound card that then provides an analog output to headphones or speakers.

Often, these sources also provide a digital output representative of an audio signal. The digital output, however, is unused. Even if used, the digital output is such that the resultant audio signal would be of a lesser quality than that from high-end audio equipment. In order for the personal computer to evolve into more powerful tool, there is need to provide an audio output that is as good as or better than audio equipment in a home entertainment system or even a professional sound system.

### SUMMARY

The present disclosure is directed to an improved audio system and method for a computer system such as a desktop computer or a laptop computer. The improved audio system enables the computer system to output a high quality audio signal that is similar to many dedicated high-end consumer or professional audio components. In other words, the output from the computer systems is as good as the signal output from audio components in a home entertainment system. In one example described below, this is accomplished by providing a component called a sample rate converter to the computer system. The sample rate converter in the example upsamples a standard 16 bit, 44.1 kHz digital audio signal inside the computer system into a 24 bit, 192 kHz enhanced digital audio signal. This signal is as good as, or better than, the signals coming from single function audio components that can cost more than the entire computer system.

In one aspect, the present disclosure is directed to an audio system for use with a computer system. The audio system includes an audio source and a signal converter. The audio source is adapted to provide a digital signal that includes a number of bits and a frequency. The number of bits of the digital signal is a “standard number of bits.” For example, the standard number of bits could be 16 bits. The frequency is at a “base frequency.” For example, the base frequency could be 44.1 kHz. Of course, other values are possible for the standard number of bits and the base frequency.

The signal converter is adapted to receive the digital signal from the audio source and provide an enhanced digital signal based on the digital signal. The enhanced digital signal is different from the digital signal in either it has a different number of bits, a different frequency, or both. In other words, the enhanced digital signal can include a “selected number of bits,” a “selected frequency,” or both. The selected number of bits is other than the standard number of bits. In one example, the selected number of bits is 24. Also, the selected frequency is other than the base frequency. In another example, the selected frequency is 192 kHz. Thus, the audio source can provide a digital signal that is 16 bits, 44.1 kHz and the signal converter can output an enhanced digital signal that is 24 bits and 192 kHz. The computer system can output the enhanced digital signal or pass the enhanced digital signal through a device such as an analog to digital converter and create an analog high fidelity output, or an enhanced analog signal.

There are several variations to this aspect of the present disclosure. For instance, more than one audio sources can provide digital signals to the signal converter. The unique digital signals from the audio sources are provided to a selector device, which then selectively passes one of the unique digital signals to the signal converter. In another instance, the signal converter has the ability to provide an enhanced digital signal, but can provide as an output instead the digital signal having the standard number of bits and the base frequency (or an analog signal based on the digital signal.) This would be suited for an audio system that is not optimized or ready to accept an enhanced digital signal.

In another aspect the disclosure is directed to a method for providing an enhanced digital audio signal. The method includes generating a digital audio signal having 16 bits and a frequency of up to about 48 kHz; converting the digital signal into an enhanced digital audio signal having up to 24 bits and a frequency of up to about 192 kHz; and transmitting from the computer system at least one of the enhanced digital audio signal and an enhanced analog signal based on the enhanced digital signal. In a variation to this aspect, generating the digital audio signal includes providing a two or more digital signals and selecting one of the digital signals to be the digital audio signal.

### BRIEF DESCRIPTION OF THE DRAWINGS

FIG. 1 shows schematic view of a computer system that serves as an environment for an audio system of the present disclosure.

FIG. 2 shows a block diagram of an environment of the present disclosure including the computer system of FIG. 1.

FIG. 3 shows a block diagram of audio components within a prior art computer system.

FIG. 4 shows a block diagram of the audio components of FIG. 3 incorporated into the new audio system of the computer system of FIG. 1.

FIG. 5 shows a block diagram of another example of an audio system of the computer system of FIG. 1.

FIG. 6 shows a block diagram of still another example of an audio system of the computer system of FIG. 1.

### DESCRIPTION

This disclosure relates to an audio system adapted for use with a computer. The disclosure, including the figures, describes the audio system and computer system with reference to a several illustrative examples. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

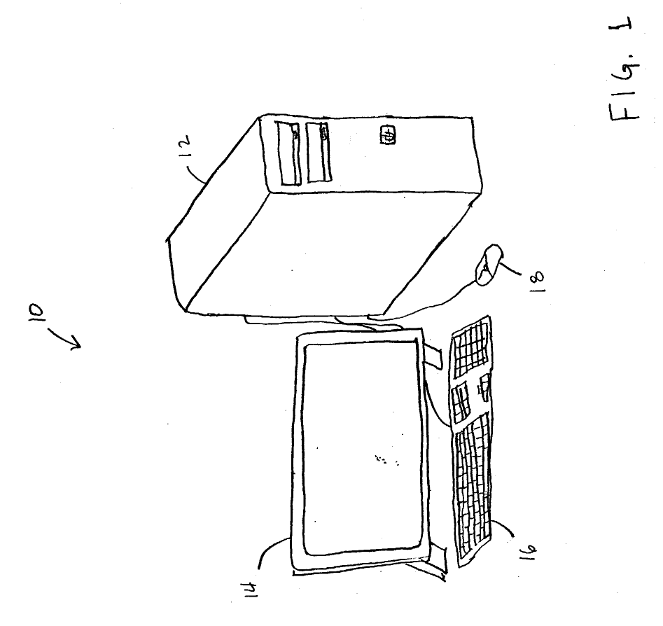

FIG. 1 shows a perspective view of a general environment of the present disclosure. More specifically, FIG. 1 shows a computer system 10. Computer system 10 generally includes a housing, or cabinet, 12, which typically contains the major electronic components of system 10, a display 14, an input device 16 and a pointing device 18.

The example shows the housing in the form of a tower, although other configurations are possible. The housing can contain several of the major electronic components of a computer system such as one or more processors included on a motherboard, random access memory, a sound card, a video card, inputs for the input device 16 and the pointing device 18, and outputs for a display device 14. The one or more processors are often general purpose processors such as those sold under the trade designation Pentium available from Intel of Santa Clara, Calif., or the like (or other manufacturers depending on the platform), or specialty processors such as an application specific integrated circuit (ASIC) produced specifically for the computer system. The housing can also contain devices such a DVD read/write or DVD read optical drive (DVD is understood to mean a high capacity storage media in the form of an optical disc and the acronym stands for digital video disc or digital versatile disc, as understood by those skilled in the art), a CD (compact disc) drive, a magnetic disk drive (or hard drive), and communication circuitry to enable the computer system to connect to a computer network. Such communication circuitry can include an Ethernet card, modem, or the like.

The display device 14 outputs visuals images generated by the computer system. Examples of display devices include cathode ray tube monitors, flat panel displays, video projectors, or the like.

The input device 16 and pointing device 18 are used to provide user selected inputs into the system 10. Examples of the input device include a keyboard, handwriting-recognition devices such as a tablet or touchpad and associated software, or speech-recognition devices such as a microphone and associated software, or the like. Input device often provide the user with the opportunity to input many different signals into the computer system. Pointing devices include a computer mouse, a trackball, track pad with associated button(s), a touch panel device in cooperation with the display device, or the like. Pointing devices often work with a graphical user interface. Pointing devices are often only able to send a few input signals to the computers systems, such as a left or right click or a single or double click.

The components of the computer system are shown as separate devices in the figure. In this case, the components are electrically coupled to the electronic components within the housing. The components are coupled through one or more standardized connections including wireless connections or wired connections such as universal serial bus (USB) or other known connections. Other types of connections are contemplated or possible. The figure shows what is often understood in the art to be a desktop system. In another example, some or all of the elements of the computer system are integrated into the cabinet. An example of such a system includes a laptop computer.

Often, the computer system includes all of the elements as shown in FIG. 1, although alternate examples are contemplated. For instance, the computer system may include two or more display devices, such as two displays or one or more displays and a video projector. Also, the system can include more than one pointing device. For example, the system may include a keyboard with a pointing device and also a separate computer mouse that may be preferred by the user. In addition, the system can include a keyboard and a speech-recognition device. The computer system might also be without a input device, a pointing device, or display device, or without any combination of more than one of these devices.

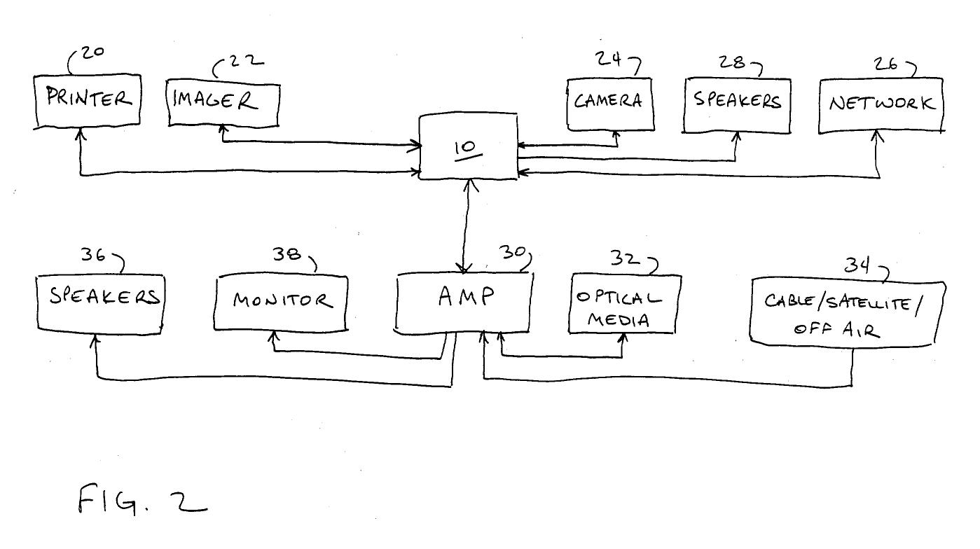

FIG. 2 shows a block diagram of an example of an environment of the computer system 10 of the present disclosure. The computer system 10 can be coupled to one or more printers 20, and can also be coupled to one or more imaging devices 22 such as scanners or the like. In the example, the system is removably coupled to one or more cameras 24 such as a digital still camera or a video camera. The computer system 10 can be connected to a network 26 such as the Internet or another local area network. Still further, the computer system is connected directly to speakers 28.

FIG. 2 also shows the computer system connected to a receiver 30, or amplifier, that is part of a home entertainment system 40. In the example shown, the receiver 30 is the hub of a high-end home theatre and audio system. The receiver is connected to one or more audio/video components 32 such as a DVD player, CD player, video cassette recorder, digital audio tape player, or the like. The receiver 30 is also connected to sources 34 to receive remote signals such as various types of satellite television, satellite radio, cable television, off-air television or radio, or the like. Such sources may include converter boxes, antennae, or the like. Audio is output through speakers 36 and video is output through monitor 38. FIG. 2 shows one example of various connections. Other configurations of home entertainment systems are contemplated. For example, the home entertainment system need not include both video and audio aspects. Electrical signals can pass both ways between the home entertainment system 40 and the computer system 10.

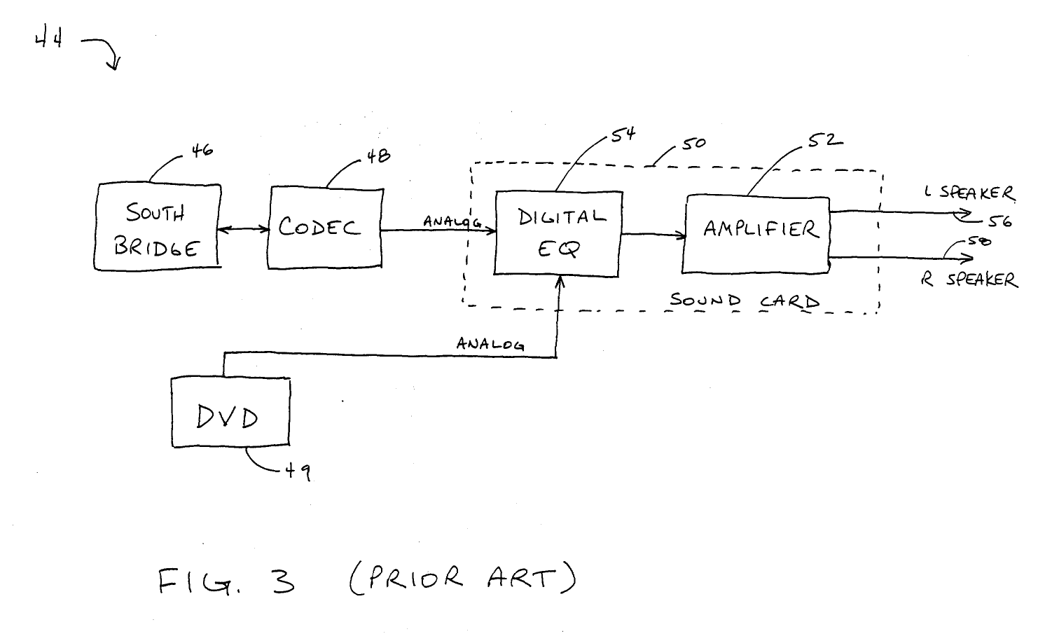

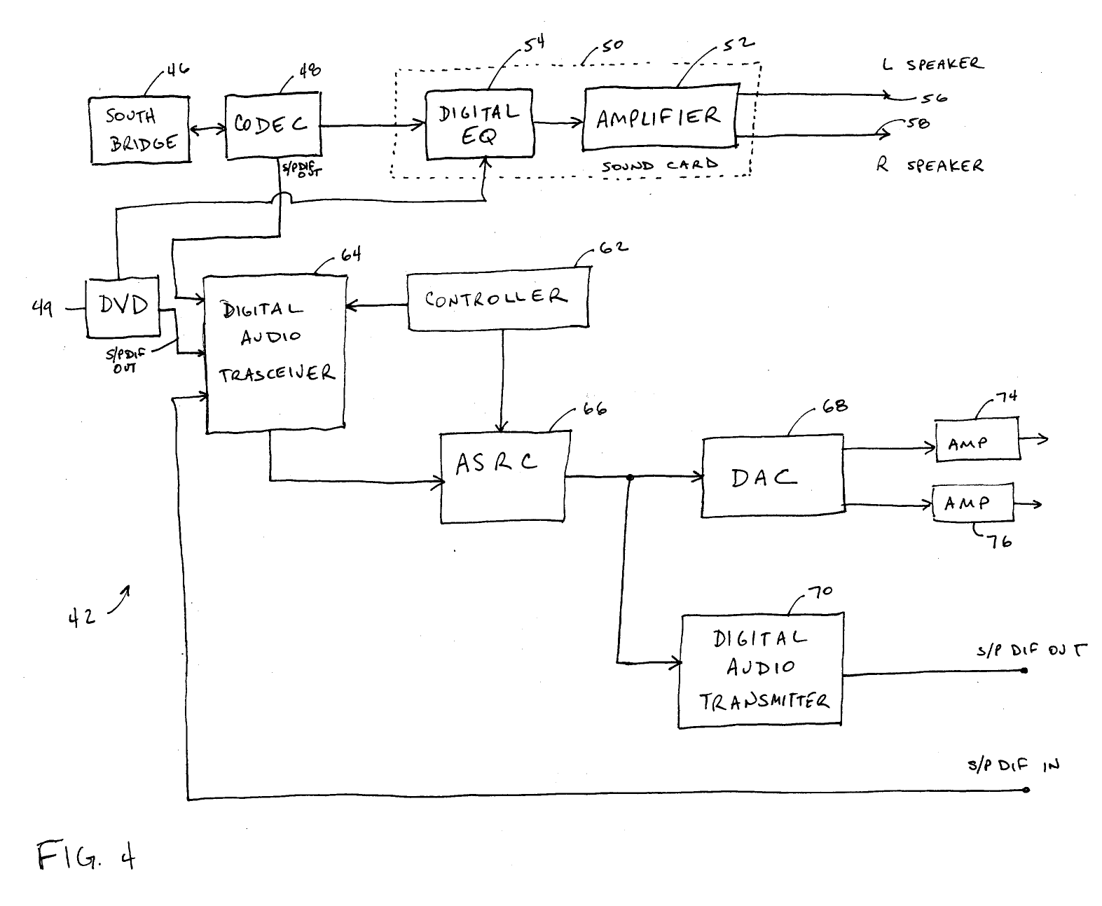

FIGS. 3 and 4 together illustrate an audio system 42 of the computer system 10. FIG. 3 shows a block diagram of audio components 44 within a prior art computer system. FIG. 4 shows a block diagram of the audio components 44 of the prior art incorporated into the audio system 42 of the present computer system 10. Like parts are labeled with like reference numerals. The audio system 42 of the present computer system 10 is adapted to be connected to the home entertainment system 40.

FIG. 3 shows a south bridge 46 of a computer system's motherboard interacts with a coder/decoder system (CODEC) 48. In the example, the CODEC system 48 is a chip, however, other configurations are possible as known in the art. The CODEC contains an analog system and a digital system. The computer system also contains a DVD drive 49 or other optical storage device that contains an analog system with an analog output and a digital system with a digital output. The analog systems of both the CODEC 48 and the DVD drive 49 are connected to the sound card 50. The sound card 50 at least contains an amplifier 52, and often also contains a digital equalizer 54. In the example, the CODEC system 48 is connected to the digital equalizer 54. The digital equalizer provides an audio signal to the amplifier 52. The amplifier 52 provides an audio signal outside of the computer system 10 to be either received by headphones or left and right stereo speakers 56, 58. The digital outputs of the CODEC system 48 and the DVD drive 49 are unused in the prior art computer system.

In the present system 10, the digital outputs of the CODEC 48 and the DVD drive 49 are provided as inputs to a digital audio transceiver 64. The digital outputs from “audio sources” such as the CODEC 48 and DVD drive 49 can be called a “digital signal.” A controller 62 selects which digital input is passed through the digital audio transceiver 64. The output of the transceiver is provided to an asynchronous sample rate converter 66, or ASRC. In the example, the ASRC 66 is capable of outputting a variety of sample rates. The controller 62 is used to select a specific sample rate for the ASRC 66. The output from the ASRC 66, i.e., an “enhanced digital signal,” is provided to a digital-to-analog converter 68 and to a digital transmitter 70. The digital-to-analog converter 68 provides a high fidelity analog signal equivalent to many high-end audio components in the home entertainment system 40, i.e., an “enhanced analog signal” that is based on the enhanced digital signal. Also, the digital transmitter 70 provides a high-quality digital output from the computer system 10 that is adapted to provide a digital input to many high-end audio components, i.e., the enhanced digital signal.

The audio system 42 is also adapted to receive a digital signal from a source outside of the computer system 10. The received digital signal is provided to the digital audio transceiver 64. In this example, the digital audio transceiver is adapted to receive at least three digital inputs.

Controller 62 can take many forms. It can exist as a separate piece of hardware or software, and can be operated by the user with a separate keyboard button located on the input device 16, on a graphical user interface, or in other ways as now known in the art. In the example shown, the controller 62 is shown as controlling the input of the transceiver 64, and the sampling of the ASRC 66. Separate controllers can be used for these tasks, or a multifunction controller can perform a plurality of tasks. Other configurations are possible.

The audio system 42 of FIG. 4 is now described with reference to a specific example of the elements. The south bridge 46 is an ALi M1535 South Bridge solution, available from Acer Laboratories, Inc., with United States offices in San Jose, Calif. The south bridge 46 in the specific example includes a controller using an AC'97 2.1 interface to interact with the CODEC chip 48. In one example, the CODEC chip 48 is an AD1981A available from Analog Devices of Norwood, Mass. The analog section of the chip 48 includes an input and output mixer, analog-to-digital converters, digital-to-analog converters, and an analog microphone analog-to-digital converter. The digital section includes the interface link, a Sony/Phillips Digital Interface (S/PDIF) (which provides the digital output of the chip 48), a signal processing engine, and sample rate converters.

The sample rate converters allow sample frequencies other than 44.1 kHz to be captured by or played from the CODEC chip 48. In the example, the AC'97 protocol requires support for two audio rates, i.e., 44.1 and 48 kHz, and four modem rates, i.e., 8, 9.6, 13.714 and 16 kHz. In addition, the CODEC chip 48 of the example supports additional audio rates of 8, 11.025, 16, 22.05 and 32 kHz, and modem rates of 24 and 48 kHz. The sample rate converters of CODEC chip 48 do not allow for significant upsampling above 48 kHz. Specifically, the sample rate converters do not allow for sampling between 96 kHz and 192 kHz or above.

The sound card 50 of the specific example includes a TAS3004 digital equalizer 54 and a TPA0132 amplifier 52, both available from Texas Instruments of Dallas, Tex. The digital equalizer 54 receives an analog signal and operates as a digital audio processing chip. Equalizer 54 includes mixing, filtering, parametric or graphical equalization, volume control, tone control, dynamic range compression and expansion, loudness and other audio processing functions. The amplifier 52 is a two-watt stereo amplifier that allows the output audio signal to be received by headphones or amplified speakers 56, 58 outside of the computer system 10.

The CODEC chip 48 and DVD ROM 49 each include an S/PDIF that provide a digital output. The digital output from each is a 16 bit, 44.1 kHz signal. In the example, both outputs are provided to the digital transceiver 64 that provides a digital audio interface. In the specific example, the transceiver 64 is an AK4114 transceiver available from Asahi Kasei Microsystems Co., of Tokyo, Japan. The transceiver in the example is adapted to receive multiple inputs and can be programmed with the controller to process only one selected input to provide a single output.

If the digital transceiver is of a type not able to receive more than one input, the outputs from the sources can be provided to an n-to-1 switch, where n equals at least the number of sources. The switch takes multiple signals and passes only one signal. The controller 62 can be used to select the output from the switch, and thus need not be connected to the transceiver in this example. If only a single digital signal is provided, such as if the computer system 10 does not include the DVD ROM 49, no switch is necessary.

The output of the transceiver 64 is sent to the ASRC 66, which in the specific example is an AD1896 available from Analog Devices of Norwood, Mass. This ASRC is capable of upsampling the 16 bit, 44.1 kHz signal into a 24 bit, 192 kHz signal. The ASRC 66 generates a superior, high fidelity signal as that compared to the CODEC 48 alone in that the signal from the ASRC provides increased data and high-quality upsampling. In the specific example, one output of the ASRC 66 is sent to an AD1852 digital-to-analog converter 68 available from Analog Devices. The left and right analog audio signal generated by the AD1852 is sent to separate high quality amplifiers 74, 76 such as OPA627 amplifiers available from Burr-Brown of Tucson, Ariz. The digital output from the computer system is provided to an S/PDIF through the digital audio transmitter 70, which can be an AK4103 available from Asahi Kasei Microsystems, Co. of Tokyo, Japan.

At the present time, not all home entertainment audio components with digital inputs are configured to receive a 24 bit, 192 kHz signal. If the user has these types of audio components, the ASRC 66 can be programmed to generate a signal compatible with the users audio components, such as the traditional 16 bit, 44.1 kHz digital signal. The ASRC 66 can be programmed from the controller 62.

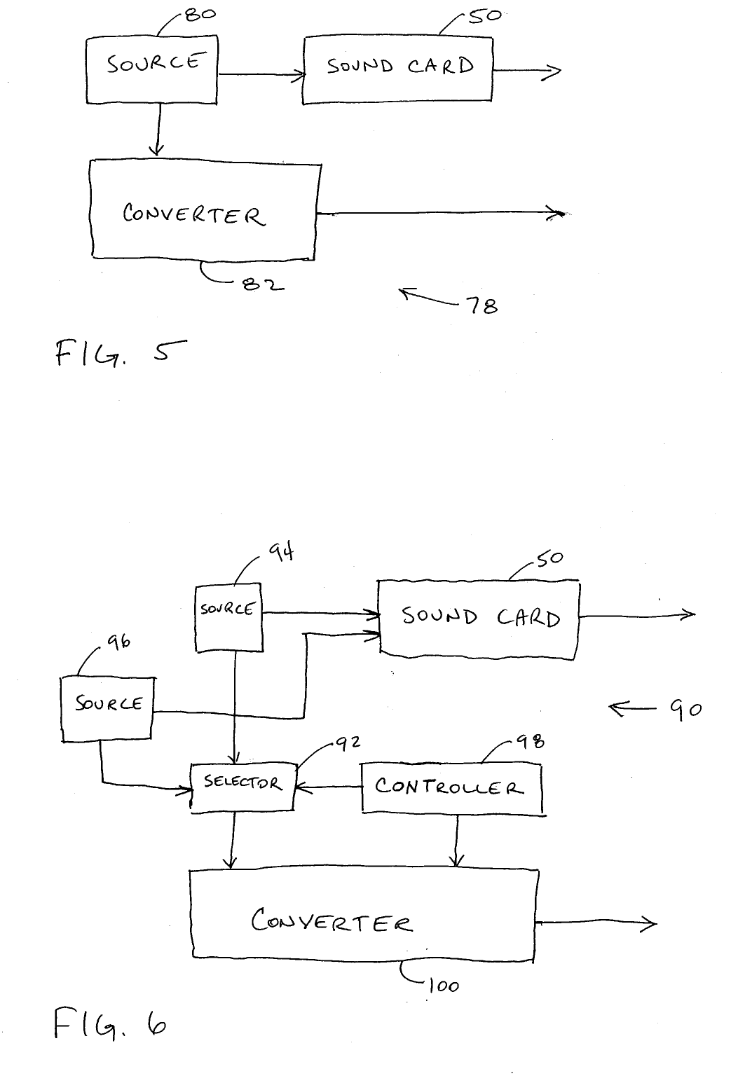

FIG. 5 shows another example of an audio system 78 for use with the computer system 10. Like parts are labeled with like reference numbers. The audio system 78 includes a source (or sources) 80 providing a digital signal, or digital signals, having a standard number of bits and a base frequency. In one example, the standard number of bits is 16 and the base frequency is any frequency up to and including 48 kHz. In one specific example, the digital audio signal is a 16 bit, 44.1 kHz signal. Accordingly, in this specific example, the standard number of bits is 16 and the base frequency is 44.1 kHz. The digital signal in the example is provided from the source 80 at an S/PDIF output, although other interfaces are contemplated. In the example shown, at least one source 80 also provides an analog signal to a sound card 50 for output outside the computer system 10, such as described above. It is contemplated that the source(s) 80 does not output an analog signal in some examples, and thus in those examples the computer system would not include a sound card configured as shown in the figure.

A digital audio signal converter 82 receives the digital signal from the source 80. The signal converter 82 can perform a number of signal processing techniques on the received digital signal. Among these signal processing techniques is the ability to sample the received digital signal to output an enhanced digital signal having at least one of a selected number of bits that is other than the standard number of bits and a selected frequency that is other than the base frequency. The selected frequency and selected number of bits can either be predetermined by the signal converter 82 or directly or indirectly selected by the user. In another example, the signal processing techniques include upsampling, or the process of interpolating a digital signal to produce an enhanced digital signal at a higher frequency and larger number of bits. In one example the selected frequency is at least two times the base frequency, and in another example the selected number of bits is one and half times the standard number of bits. In one specific example, the upsampled signal has a frequency of between 96 kHz and 192 kHz. In another specific example, the enhanced digital signal is a 24 bit, 192 kHz signal. In one example, the enhanced digital signal is output from the computer system 10 at an S/PDIF, although other interfaces are contemplated. In another example, the enhanced digital signal is passed through a signal processing device such as a digital-to-analog converter to create an enhanced analog signal based on the enhanced digital signal. The enhanced audio signal can then be output from the signal converter 82 and computer system 10 and an analog interface. Of course, both the enhanced digital signal and the enhanced analog signal can be out from the signal converter 82.

As used in this disclosure, the word “between” is intended to include the limits of the define range. For example, the range of “between 96 kHz and 192 kHz” includes 96 kHz and 192 kHz. Additionally, numerical values of frequency are approximate and ranges and numerical definitions are intended to include accepted tolerances, workable deviations, or the like.

In a variation to the example shown in FIG. 5, the signal converter offers the user the ability to select the type of signal to be output. For example, the user can select whether the signal output from the computer system 10 includes the standard number of bits and the base frequency, or whether the signal output from the computer system 10 is an enhanced digital signal with at least one of a number of bits other than the standard number of bits and a frequency that is other than the base frequency. The output can than be either the digital signal with the standard number of bits and the base frequency, or the enhanced audio signal. If only one output from the computer system is provided, the enhanced audio signal and digital signal are output at separate times. In some examples, two or more outputs from the computer system are provided, and the digital signal and at least one enhanced digital signal can be output at the same time. In this example, the output can be, instead or in addition to the digital outputs, an analog signal based on the digital signal, an enhanced analog signal based on the enhanced digital signal, or both.

FIG. 6 shows still another example of an audio system 90 that includes a plurality of sources each providing a digital signal to a selector device 92. In one example, the selector device 92 includes a digital audio transceiver with multiple inputs. In another example, the selector device 92 includes an n-to-1 switch wherein n is the number of sources providing signals to the switch. FIG. 6 shows an example of two sources 94, 96 each providing a digital signal to the selector device 92. The selector device 92 outputs one of the signals. In the another example, a switch would be a 2 to 1 switch that would pass either the signal from source 94 or source 96. The user can control, either directly or indirectly through controller 98, which signal to output from the selector device 92. The sources 94, 96 are shown as components within the computer system 10. Sources from outside the computer system 10 can provide a digital signal to the selector device 92. In one example, at least one source is within the computer system 10. Examples of sources include the computer system motherboard, a DVD drive, as described above, and other sources such as CD ROM drives, magnetic disk drives, tape drives, or the like, that output from the source a digital signal. Examples of sources from outside the computer system include external drives, consumer or professional audio equipment with digital outputs, or the like.

In the example shown, the sources 94, 96 also provide an analog signal to a sound card 50 for output outside the computer system 10, such as described above. It is contemplated that at least one of the sources, either from within the computer system or outside the computer system 10, does not output an analog signal in some examples. In that case, the sources need not be connected to the sound card 50. In the case where none of the sources provide an analog signal, the computer system would not include a sound card configured as shown in the figure.

The signal converter 100 receives the output from the selector device 92 and applies signal processing techniques as describe with reference to converter 82 from FIG. 5. The signal converter 100, however, need not be included with the controller 98. Controller 98 operates to select output frequency, output number of bits, or both, of the signal conversion, if any. The signal converter 100 includes the ability to upsample the input digital signal to a 24 bit, 192 kHz enhanced digital signal, but may output a 16 bit, 44.1 kHz digital signal instead (or an analog signal based on the digital signal or the analog signal). Of course, the signal converter 100 is not limited to output just two different signal or the respective analog signals based upon these two signals. Instead, the signal converter 100 selects the actual signal conversion over a wide range of bits and frequencies.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details and structures described herein, but rather by the appended claims and equivalents.

What is claimed is:

1. An audio system adapted for use within a computer system, the audio system including:
an audio source adapted to provide a digital signal having a standard number of bits and a base frequency;
a signal converter operably coupled to the audio source, the signal converter adapted to receive the digital signal and provide an enhanced digital signal wherein the enhanced digital signal includes at least one of a selected number of bits other than the standard number of bits and a selected frequency other than the base frequency; and
wherein the signal converter is adapted to output from the computer system at least one of the enhanced digital signal and an enhanced analog signal based on the enhanced digital signal.

2. The audio system of claim 1 wherein the audio source is further adapted to provide an analog audio signal.

3. The audio system of claim 1 wherein the signal converter includes an asynchronous sample rate converter.

4. The audio system of claim 3 wherein the signal converter further includes a digital transceiver and a digital transmitter, each operably coupled to the asynchronous sample rate converter.

5. The audio system of claim 4 wherein the signal converter further includes a digital-to-analog converter operably coupled to the asynchronous sample rate converter, and wherein the digital-to-analog converter receives the enhanced digital signal and provides the enhanced analog signal.

6. The audio system of claim 1 wherein the signal converter is adapted to output from the computer system both the enhanced digital signal and the enhanced analog signal.

7. The audio system of claim 1 wherein the selected number of bits is greater than the standard number of bits and the selected frequency is greater than the base frequency.

8. The audio system of claim 7 wherein the selected number of bits is one and a half times the standard number of bits and the selected frequency is at least twice the base frequency.

9. The audio system of claim 1 wherein the standard number of bits is 16 and the selected number of bits is 24; and the base frequency is 44.1 kHz and the selected frequency is 192 kHz.

10. An audio system adapted for use within a computer system, the audio system including:
at least one audio source adapted to provide an analog audio signal and a digital audio signal, wherein the digital audio signal includes a standard number of bits and a base frequency;
a sound card operably coupled to the at least one audio source, the sound card adapted to receive the analog signal and provide an analog audio output from the computer system;
a signal converter operably coupled to the at least one audio source, the signal converter adapted to receive the digital signal and provide an enhanced digital signal wherein the enhanced digital signal includes at least one of a selected number of bits other than the standard number of bits and a selected frequency other than the base frequency; and
wherein the signal converter is adapted to output from the computer system at least one of the enhanced digital signal and an enhanced analog signal based on the enhanced digital signal.

11. The audio system of claim 10 wherein the sound card includes an amplifier.

12. The audio system of claim 11 wherein the sound card further includes a digital equalizer operably coupled to the amplifier.

13. An audio system adapted for use with a computer system, the audio system comprising:
a plurality of audio signal sources, wherein the audio signal sources are each adapted to at least output a unique digital audio signal;
a selector device adapted to receive each of the unique digital audio signals and output a selected unique digital audio signal;
a signal converter adapted to receive the selected unique digital signal and provide an enhanced digital signal wherein the enhanced digital signal includes at least one of a selected number of bits other than the standard number of bits and a selected frequency other than the base frequency; and
wherein the signal converter is adapted to output from the computer system at least one of the enhanced digital signal and an enhanced analog signal based on the enhanced digital signal.

14. The audio system of claim 13 wherein the plurality of audio signal sources includes n signal sources, and the selector device is a switch having n inputs and one output.

15. The audio system of claim 13, and further comprising a controller, wherein the controller operates the selector device to select the unique digital audio signal.

16. The audio system of claim 15 wherein the controller further selects the selected number of bits and the selected frequency,

17. An audio system for use with a computer system, the audio system comprising:
a source providing a digital audio signal having 16 bits and a frequency of 44.1 kHz; and
a converter circuit receiving the digital audio signal, the converter circuit including an asynchronous sample rate converter;
wherein the converter circuit is adapted to output the digital audio signal or an enhanced digital audio signal having a frequency selected to be between 96 kHz and 192 kHz.

18. The audio system of claim 17 wherein the frequency selected is one of 96 kHz and 192 kHz.

19. A computer system, comprising:
means for generating a digital audio signal having a standard number of bits and a base frequency; and
means for converting the digital audio signal to an enhanced digital audio signal having a selected number of bits greater than the standard number of bits and a selected frequency equal to at least two times the base frequency;
wherein the means for converting selectively outputs from the computer system one of the digital audio signal or the enhanced digital audio signal.

20. An audio system adapted for use within a computer system, the audio system including:
an audio source adapted to provide a digital signal having a standard number of bits and a base frequency;
a signal converter adapted to receive the digital signal and provide an enhanced digital signal;
wherein the enhanced digital signal is at least one of:
a selected number of bits that is other than the standard number of bits, and
a selected frequency that is other than the base frequency; and
wherein the signal converter is adapted to output both the digital signal and the enhanced digital signal.

21. The audio system of claim 20 wherein the signal converter is adapted to provide the enhanced digital signal to have a selected number of bits other than the standard number of bits and the selected frequency to be other than the base frequency.

22. The audio system of claim 20 wherein only one of the digital signal and the enhanced digital signal are output from the computer system at a time.

23. A method for providing an enhanced digital audio signal from a computer system, the method comprising:
generating a digital signal having a standard number of bits and a base frequency of up to about 48 kHz;
converting the digital signal into an enhanced digital signal having up to 24 bits and a frequency of up to about 192 kHz; and
transmitting from the computer system at least one of the enhanced digital audio signal and an enhanced analog signal based on the enhanced digital signal.

24. The method of claim wherein generating the digital signal includes providing a plurality of unique digital signals and selecting one of the plurality of digital signals to be the digital signal.

25. The method of claim wherein the digital signal is a 16 bit, 44.1 kHz signal.

26. The method of claim wherein the enhanced digital signal is a 24 bit, 192 kHz signal.

27. A method of providing a digital audio signal
generating a digital signal having a standard number of bits and a base frequency; and
selecting an output signal that is one of
a digital signal having the standard number of bits and the base frequency, or
an enhanced digital signal that is includes a number of bits that is greater than the standard number of bits and a frequency that is greater than the base frequency.
